(19) United States
(12) Patent Application Publication
(10) Pub. No.: US 2012/0261535 A1
(43) Pub. Date: Oct. 18, 2012

(54) NON-PENETRATING MOUNT FOR AN ANTENNA

(76) Inventor: Joshua Blake, San Diego, CA (US)

(21) Appl. No.: 13/086,339

(22) Filed: Apr. 13, 2011

(51) Int. Cl. H01Q 1/12; F16B 2/06

(52) U.S. Cl. 248/226.11

(57) ABSTRACT

A non-penetrating mount for an antenna having a base having a first side with a first planar surface, a plate having a second planar surface wherein the plate is configured to reside within the base and wherein the plate is configured to lie in a plane that is parallel to the first side of the base wherein the plate is configured to move toward and away from said base, wherein the base and the plate each include two or more of friction elements configured to frictionally engage a rafter without penetrating through said rafter from a first side of said rafter to a second side of said rafter.

### BACKGROUND OF THE INVENTION

1. Field of the Invention

One or more embodiments of the invention are related to the field of mounts. More particularly, but not by way of limitation, one or more embodiments of the invention enable a non-penetrating mount for an antenna such as a satellite dish.

2. Description of the Related Art

Standard mounts for satellite dishes are generally bolted onto rafters, which requires holes to be drilled in the rafters.

An attempt to improve upon the invasive mounting techniques known is described in U.S. Pat. No. 7,683,853 to Michaelis, filed 28 Aug. 2006. This is an example of a non-invasive antenna mount that attaches to a raft without drilling holes through the rafter. This particular mount teaches a “compression member” that includes either a flat surface (42), a compression liner (80), a single large protruding compression member (152) or requires two screws offset vertically into the device (64) and (65) to create a “differential stress”, i.e., that increases as the distance from the proximate edge of a rafter increases. The problem with the flat surface (42) is that a larger force is required to hold the mount against the rafter, since the coefficient of static friction is generally lower for a flat surface. The problem with the compression liner (80) is that a separate component must be utilized to increase the coefficient of static friction. The problem with a single large protruding element (152) is that the rafter undergoes highly localized stress and can split or at least require significant filling if the mount is ever removed from the rafter. The problem with two vertically offset screws (64) and (65) is the need to machine more holes in the apparatus and supply more parts with the apparatus, in addition to a more difficult installation procedure. Hence, the apparatus is an improvement over drilling through the rafter, but still requires more force to be utilized that is necessary.

For at least the limitations described above there is a need for a non-penetrating mount for an antenna that requires minimal parts and minimal force to hold the mount on a rafter and which produces minimal damage to the rafter.

### BRIEF SUMMARY OF THE INVENTION

One or more embodiments described in the specification are related to a non-penetrating mount for an antenna. Embodiments of the invention include a plate and base having a plurality of friction elements that may be implemented as coupled (manufactured onto the flat plate and base) or integral friction elements (made from the flat plate and base, using the material of the plate and base themselves) and which may protrude from or into the plate and base. In other words the deviations from the plane that makes up the face surfaces of the plate and base can be concave, convex or any geometric shape that extends out of or into the plate and base, wherein “out of” refers to friction elements that point toward the rafter, and “into” refers to indentations that extend away from the rafter, i.e., into the face of the plate and base.

The base may include an extender that allows for an arm to be coupled with the base in an extendable manner. The end of the arm may also include a rotation joint to which a J-pipe is coupled. A satellite dish or other antenna is then coupled with the end of the J-pipe. The plate and base, when forced together on opposing sides of a rafter, enable embodiments of the invention to couple with the rafter in a non-intrusive manner and with minimal damage to the rafter, with minimal required parts. The base and plate are also configured so that minimal force must be utilized to hold embodiments of the invention onto a rafter.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a perspective view of an embodiment of the invention. Antenna

FIG. 2 illustrates the embodiment of FIG. 1 with hidden lines shown.

FIG. 3 illustrates a side view of an embodiment of the invention.

FIG. 4 illustrates a top view of an embodiment of the invention.

FIG. 5 illustrates a front view of an embodiment of the invention.

FIG. 6A illustrates a perspective view of a first embodiment of the base.

FIG. 6B illustrates a perspective view of a second embodiment of the base.

FIG. 7A illustrates a front view of a first embodiment of the base.

FIG. 7B illustrates a front view of a second embodiment of the base.

FIG. 8 illustrates a side view of the base.

FIG. 9A illustrates a top view of a first embodiment of the base.

FIG. 9B illustrates a top view of a second embodiment of the base.

FIG. 10A illustrates a perspective view of a first embodiment of the plate.

FIG. 10B illustrates a perspective view of a second embodiment of the plate.

FIG. 11A illustrates a top view of a first embodiment of the plate.

FIG. 11B illustrates a top view of a second embodiment of the plate.

FIG. 12A illustrates a front view of a first embodiment of the plate.

FIG. 12B illustrates a front view of a second embodiment of the plate.

FIG. 13A illustrates a side view of a first embodiment of the plate.

FIG. 13B illustrates a side view of a second embodiment of the plate.

FIG. 14A illustrates a close-up view of a first embodiment of the friction elements.

FIG. 14B illustrates a close-up view of a second embodiment of the friction elements.

FIG. 15 illustrates a perspective view of an embodiment of the arm.

FIG. 16 illustrates a top view of an embodiment of the arm.

FIG. 17 illustrates a front view of an embodiment of the arm.

FIG. 18 illustrates a side view of an embodiment of the arm.

FIG. 19 illustrates a perspective view of an embodiment of the J-pipe.

FIG. 20 illustrates a top view of an embodiment of the J-pipe.

FIG. 21 illustrates a front view of an embodiment of the J-pipe.

FIG. 22 illustrates a side view of an embodiment of the J-pipe.

FIG. 23 shows a picture of an embodiment of the invention mounted on a test rafter.

FIG. 24 shows a picture of the resulting minimally damaging indentations left on the rafter after an embodiment of the invention is removed from the rafter.

### DETAILED DESCRIPTION

A non-penetrating mount for an antenna will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

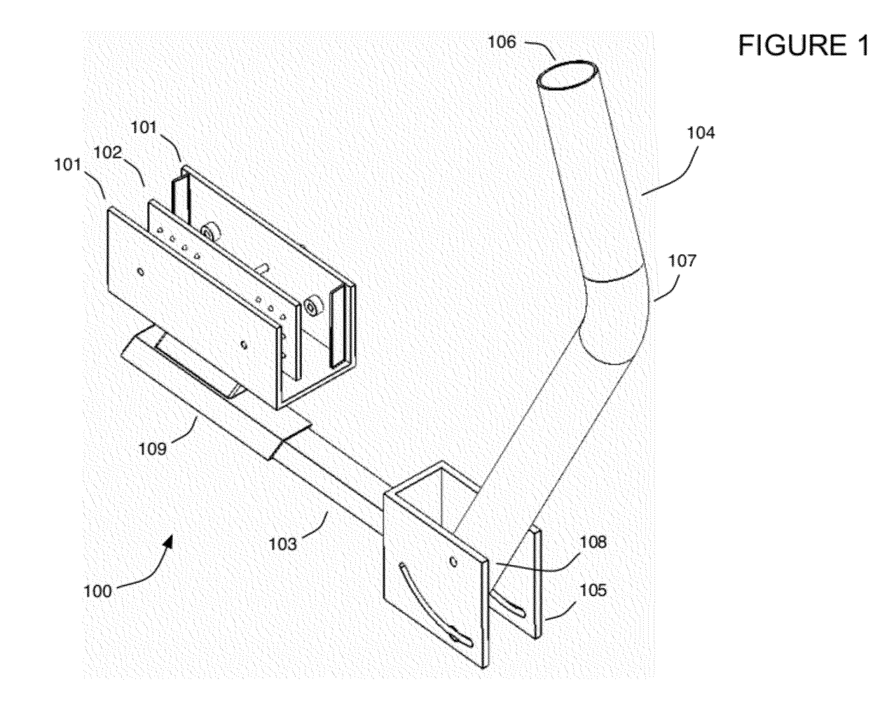

FIG. 1 illustrates a perspective view of an embodiment of the invention. As shown, non-penetrating mount for an antenna 100 includes base 101, plate 102, arm 103, J-pipe 104 that couples with arm 103 via optional rotation joint 105, specifically at joint end 108 of J-pipe 104. An antenna may be mounted on antenna mount end 106, of J-pipe 104. J-pipe 104 also includes bend 107. Optional extender 109 allows for arm 103 to move J-pipe 104 away from or towards base 101. Base 101 and plate 102 include a plurality of friction elements 110 that may be implemented as coupled friction elements, for example welded on, or integral friction elements, for example molded or forged into or out of the plane which defines the main portion of both base 101 and plate 102. Base 101 and plate 102, when forced together on opposing sides of a rafter, (not shown but which fits within the space between base 101 and plate 102) enable embodiments of the invention to couple with the rafter in a non-intrusive manner and with less potential damage to the rafter than is possible with known devices. Plate 102 is configured so that minimal force must be utilized to hold embodiments of the invention onto a rafter. For example, by asserting one or more force elements, such as one or more bolts to drive plate 102 towards base 101, non-penetrating mount for an antenna 100 is thus coupled with a rafter and provides a fixed installation for an antenna or satellite dish without requiring holes to be drilled through the rafter. If non-penetrating mount for an antenna 100 is removed from the rafted, no damage to the rafter occurs and no holes need to be patched since any indentations are very small.

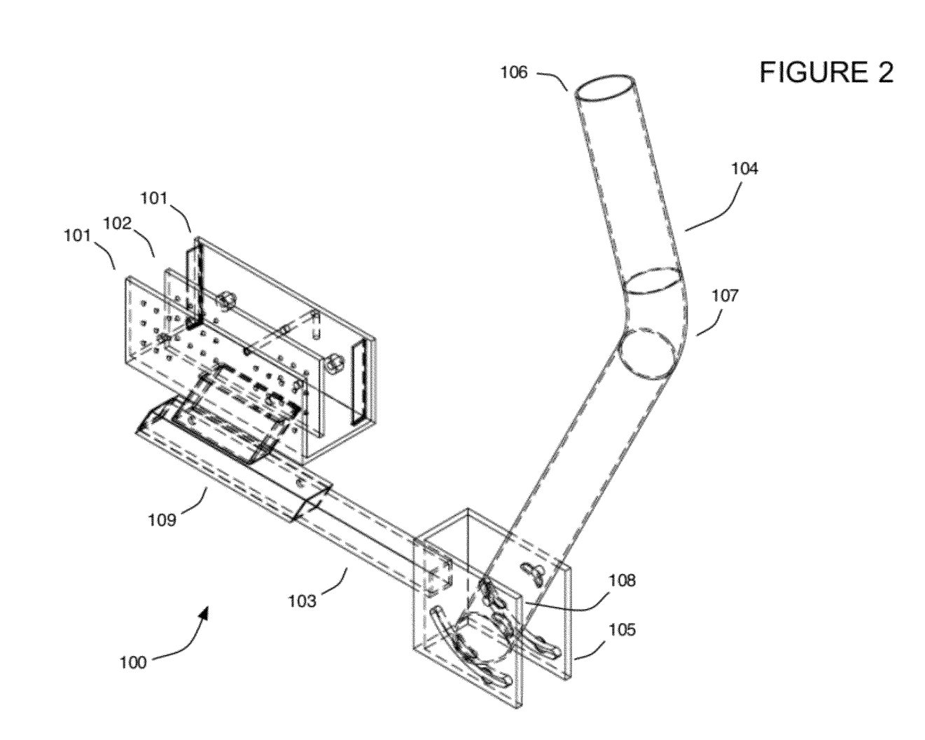

FIG. 2 illustrates the embodiment of FIG. 1 with hidden lines shown. Opposing sides of base 101 and plate 102 can be seen with friction elements 110.

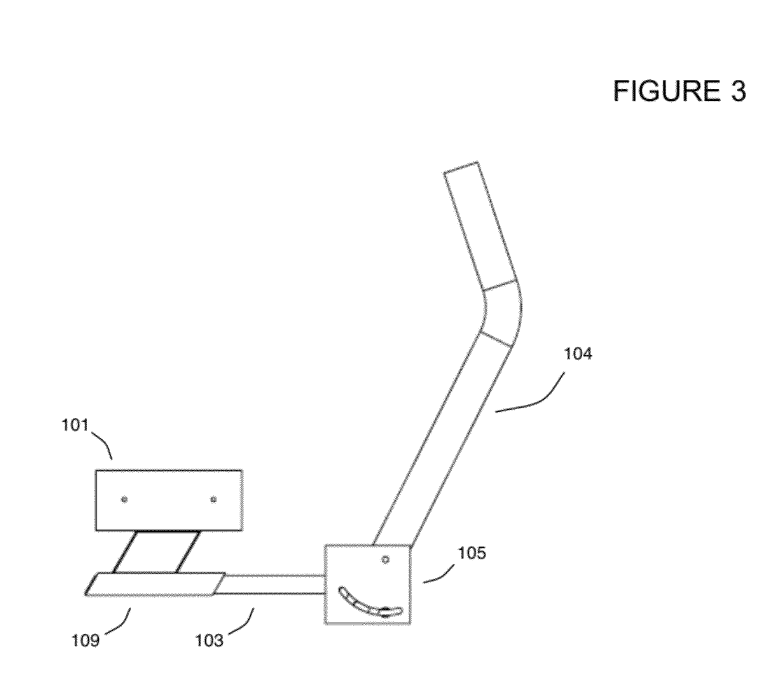

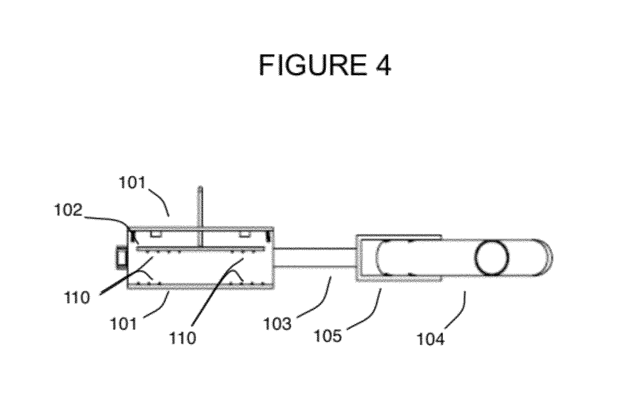

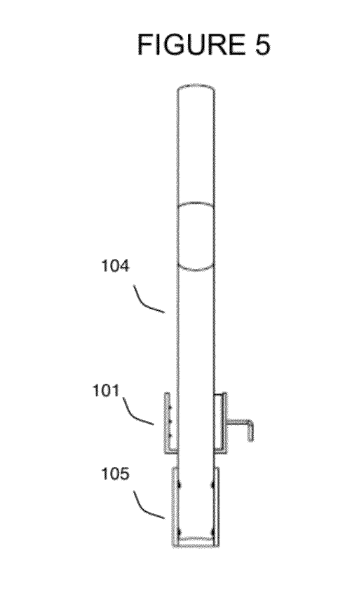

FIG. 3 illustrates a side view of an embodiment of the invention. FIG. 4 illustrates a top view of an embodiment of the invention. FIG. 5 illustrates a front view thereof.

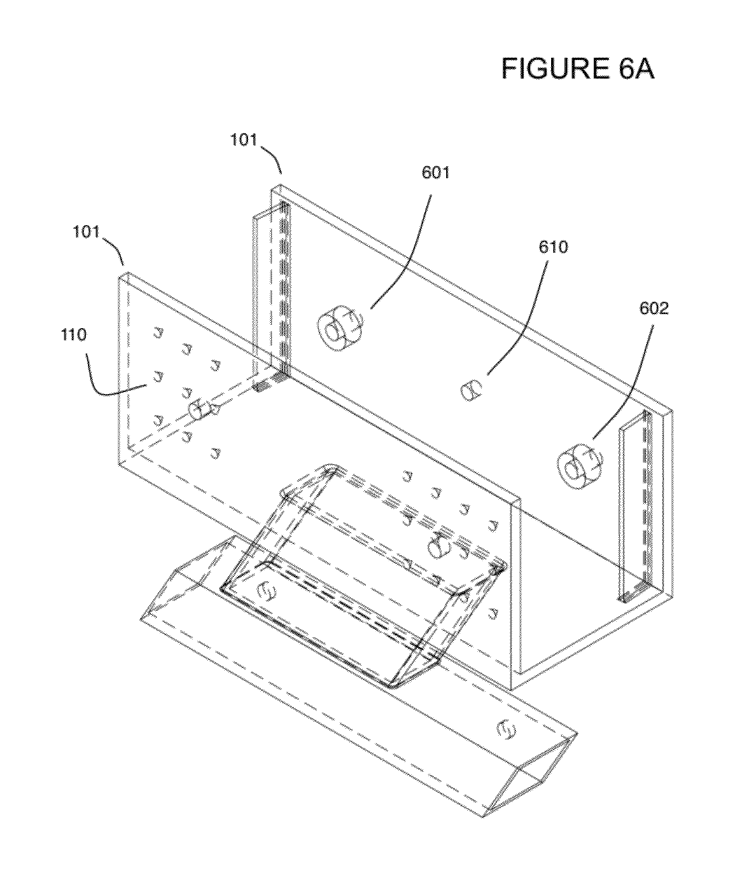

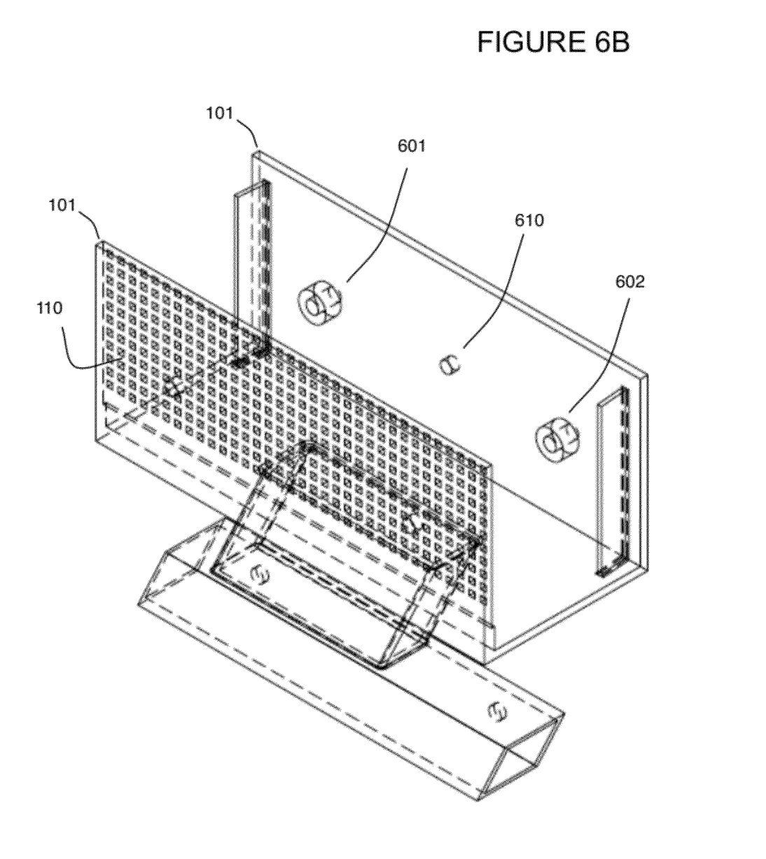

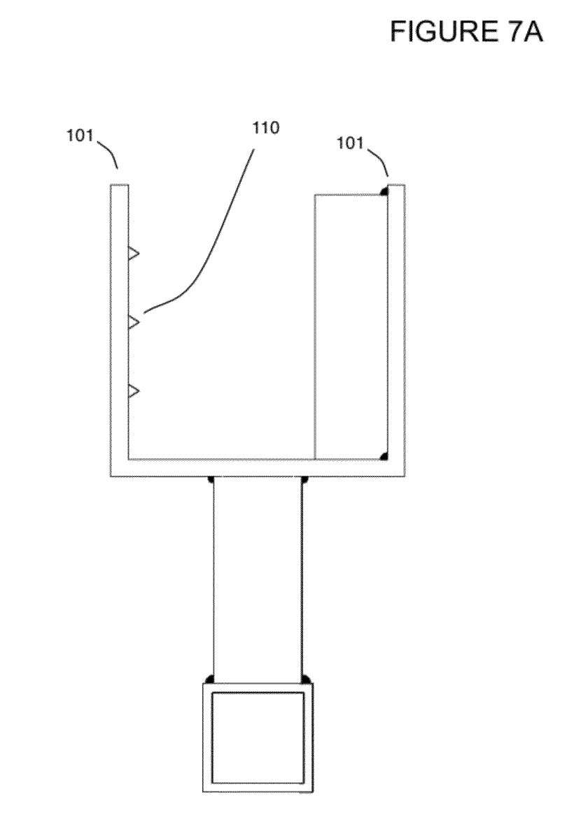

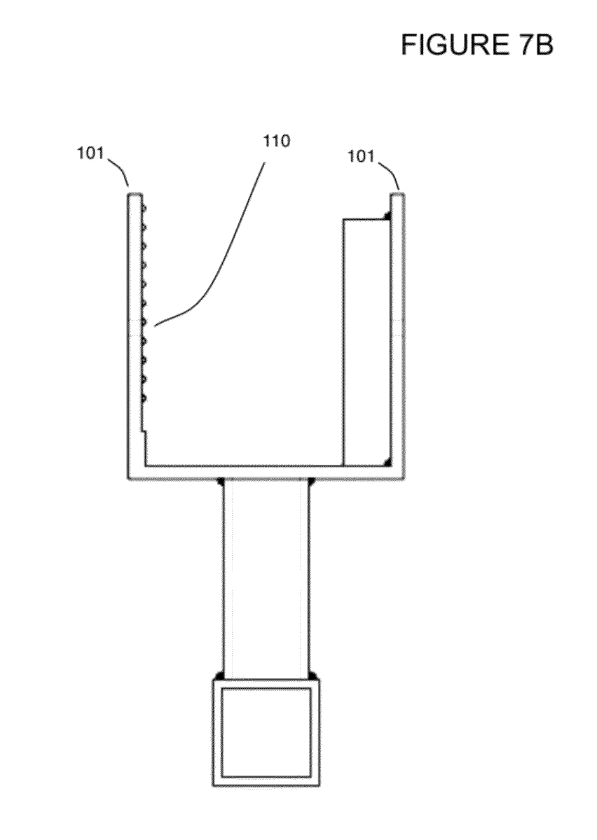

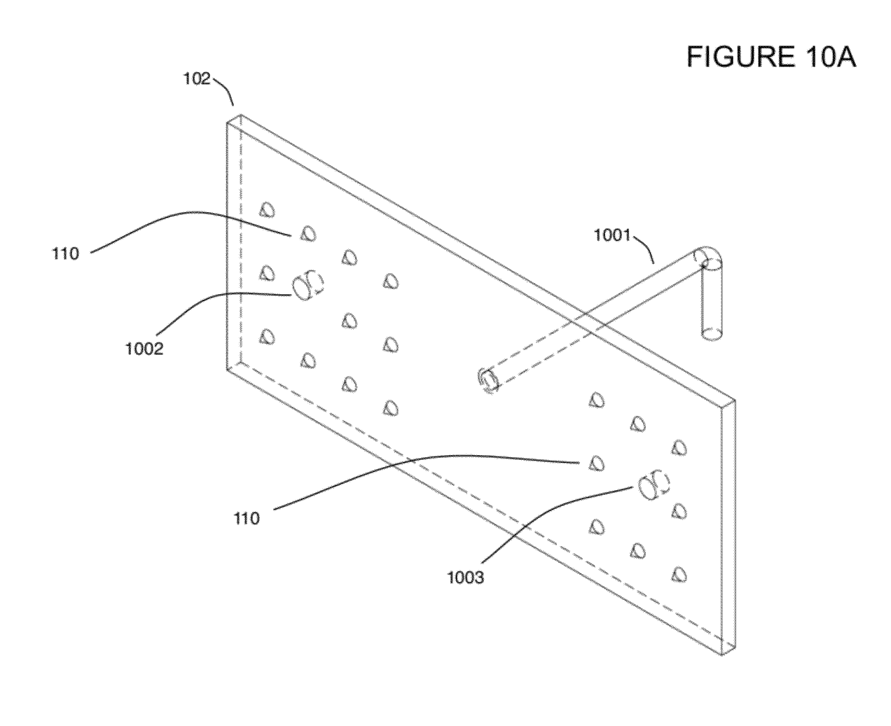

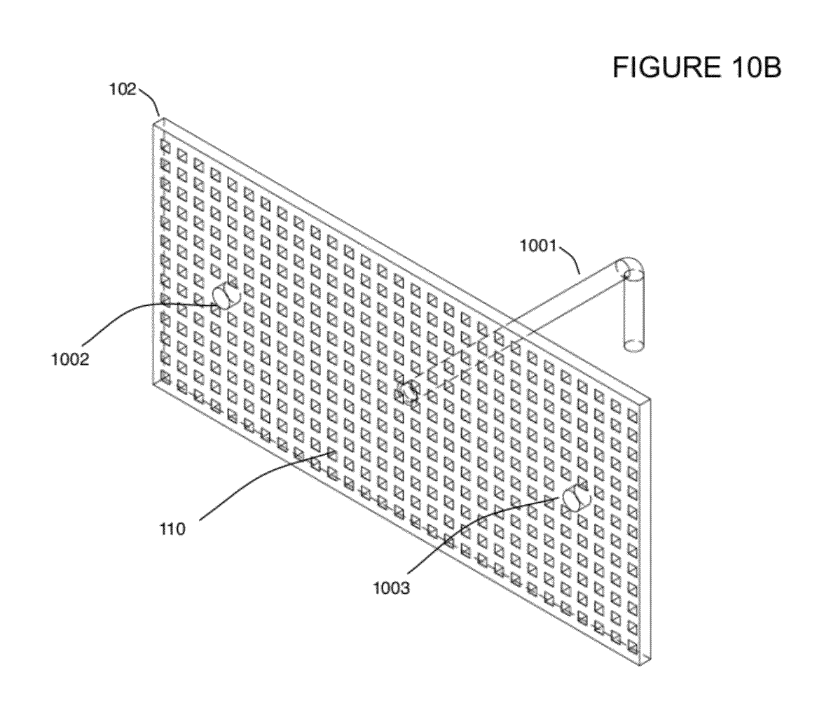

FIG. 6A illustrates a perspective view of a first embodiment of the base. Force elements 601 and 602 may be implemented as threaded nuts, wherein bolts (not shown for brevity) that are rotated in force elements 601 and 602 force plate 102 towards the opposing portion of the base (left side of FIGS. 7A and 7B). Alternatively, force elements 601 and 602 may be replaced by a threaded nut in hole 610 so that only one force element is utilized to force the plate towards the opposing base face. Alternatively, hold 610 may be utilized to allow safety L-pin 1001 as shown in FIGS. 10A and 10B to keep plate 102 from falling out of the apparatus during installation for example. Friction elements 110 in this embodiment may be implemented as several protrusions that extend into or out of the plane that defines the inner face of base 101. FIG. 6B illustrates a perspective view of a second embodiment of the base. Friction elements 110 in this embodiment may be implemented as a higher number of protrusions that extend into or out of the plane that defines the inner face of base 101 as compared with the embodiments shown in FIG. 6A for example.

FIG. 7A illustrates a front view of a first embodiment of the base showing a few friction elements 110. FIG. 7B illustrates a front view of a second embodiment of the base showing a large number of friction elements.

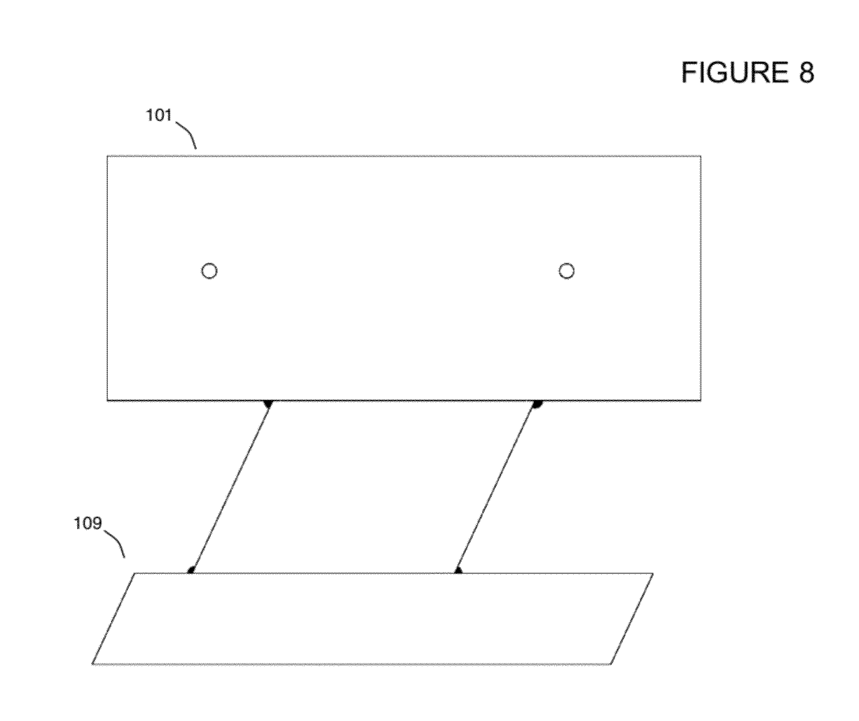

FIG. 8 illustrates a side view of the base showing optional extender 109, that may be replaced by arm 103 for example if no extension functionality is required.

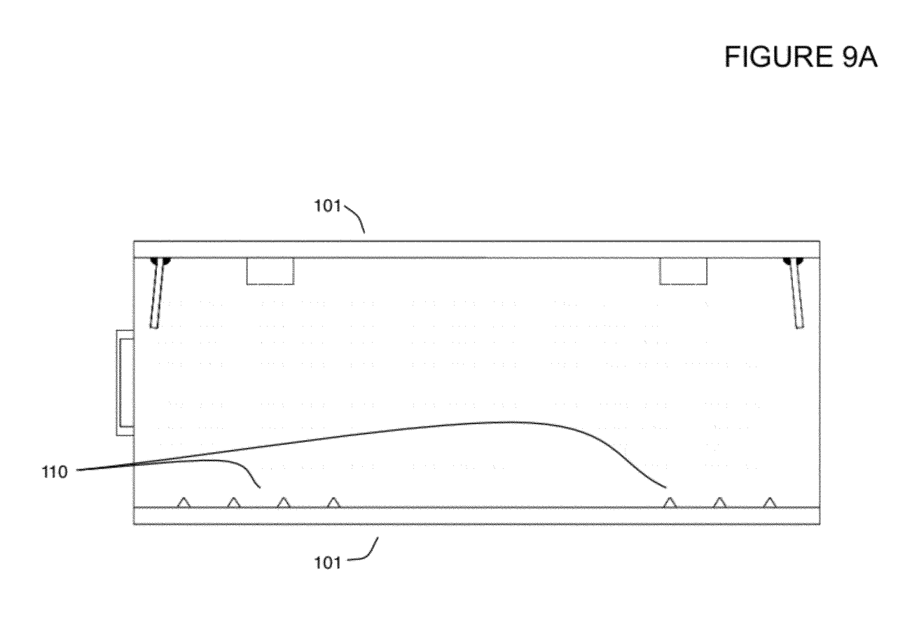

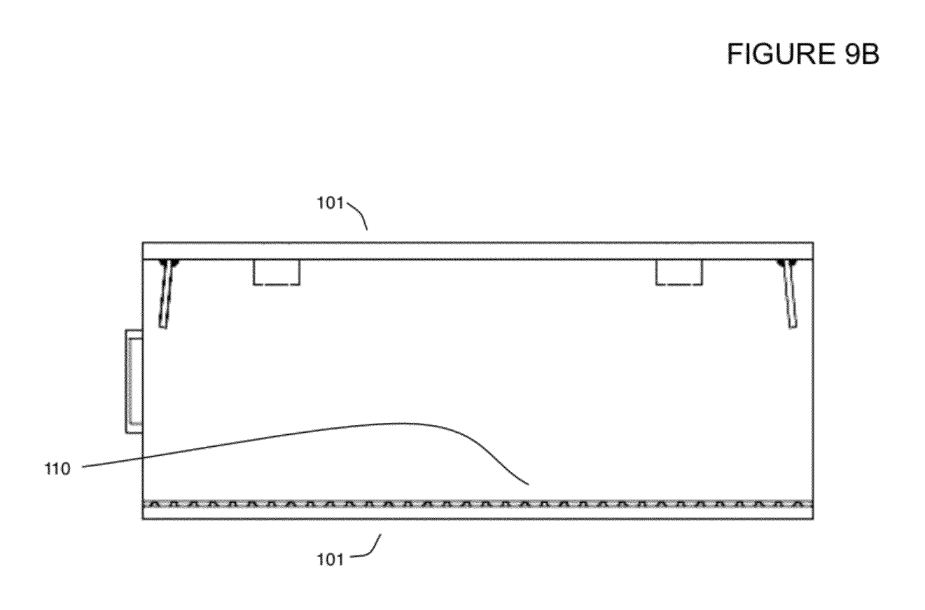

FIG. 9A illustrates a top view of a first embodiment of the base showing two general areas having friction elements 110. FIG. 9B illustrates a top view of a second embodiment of the base showing a large number of friction elements 110 covering in this embodiment a majority of the area of the base plane that defines the inner face of base 101.

FIG. 10A illustrates a perspective view of a first embodiment of plate 102 showing a plurality of friction elements 110 in a plurality of general areas along the plane that plate 102 generally lies within, but for example not entirely. FIG. 10B illustrates a perspective view of a second embodiment of the plate showing a plurality of friction elements 110 extending over most of the face of plate 102. In addition, FIGS. 10A and 10B show L-pin 1001 that adds a measure of safety during installation in that L-pin 1001 keeps plate 102 from falling out of the apparatus during installation when L-pin 1001 is inserted into hole 610 (see FIGS. 2 and 6) for example. Holes 1002 and 1003 may optionally be included wherein these holes allow the ends of bolts (not shown for brevity) or portions thereof to remain centered and hence keep the plate centered during installation. The bolts engage force elements 601 and 602, for example nuts, to force the plate towards the opposing base face. Holes 1002 and 1003 may also be implemented as dents or indentations or eliminated altogether. Alternatively, L-pin 1001 can be threaded and hole 610 can be implemented as a threaded nut instead of a simple hole in order to implement a 1 force element embodiment. In this case, the end of L-pin 1001 that engages plate 102 may be rotationally coupled to plate 102. Alternatively, a fixed attachment on the L-pin to plate 102 that is not rotationally mounted can be utilized in another embodiment of the invention so long as a nut is engaged onto L-pin 1001 on the inside of the right wall of base 101, i.e., right side of FIGS. 7A and 7B. In this configuration a slot may be located in general area 901 of base 101 (as per FIGS. 9A and 9B) to allow for rotation of the internally nut from outside of base 101.

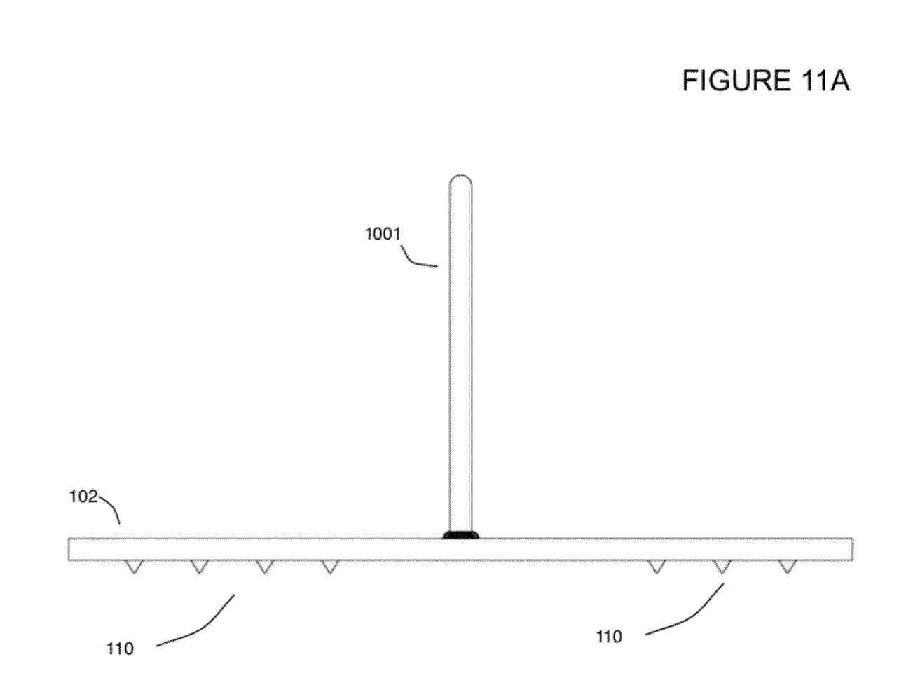

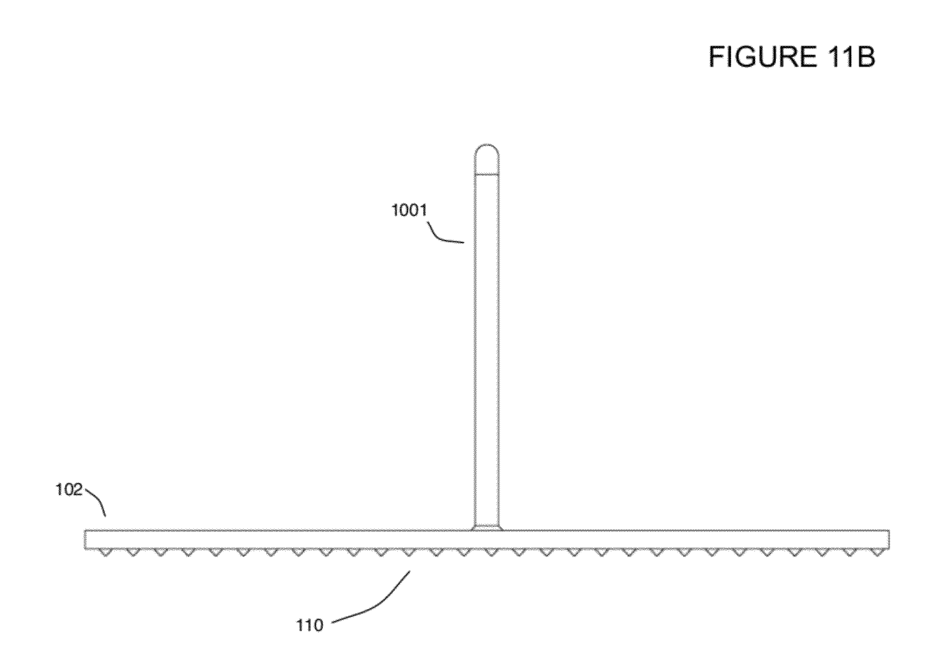

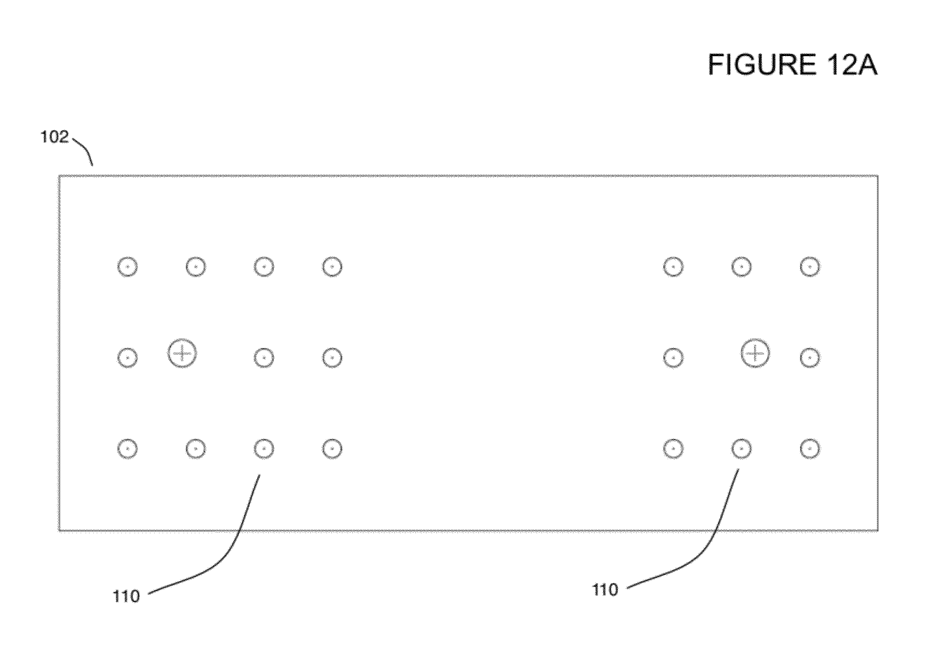

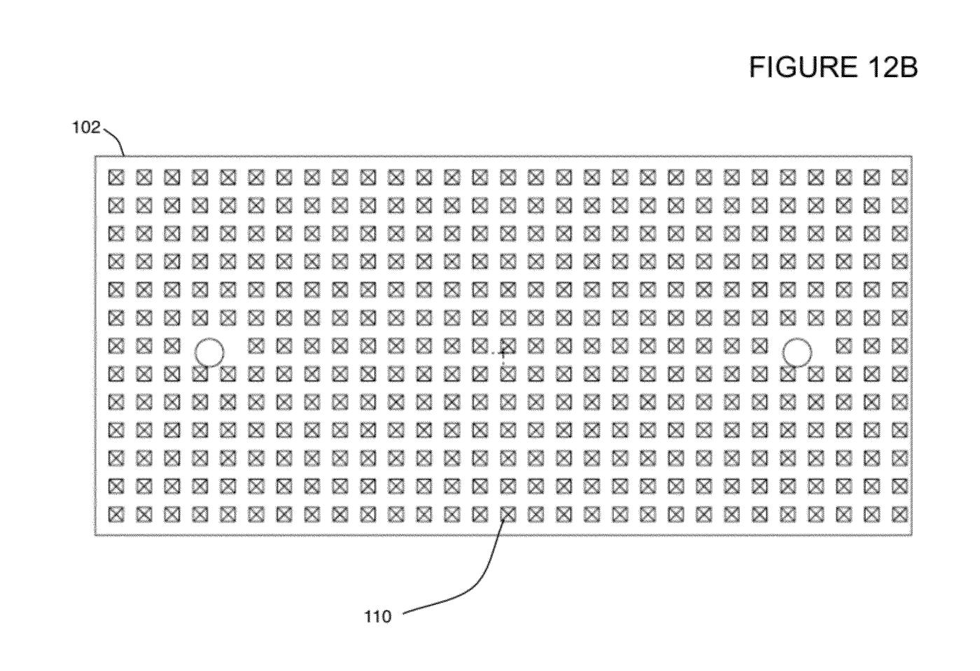

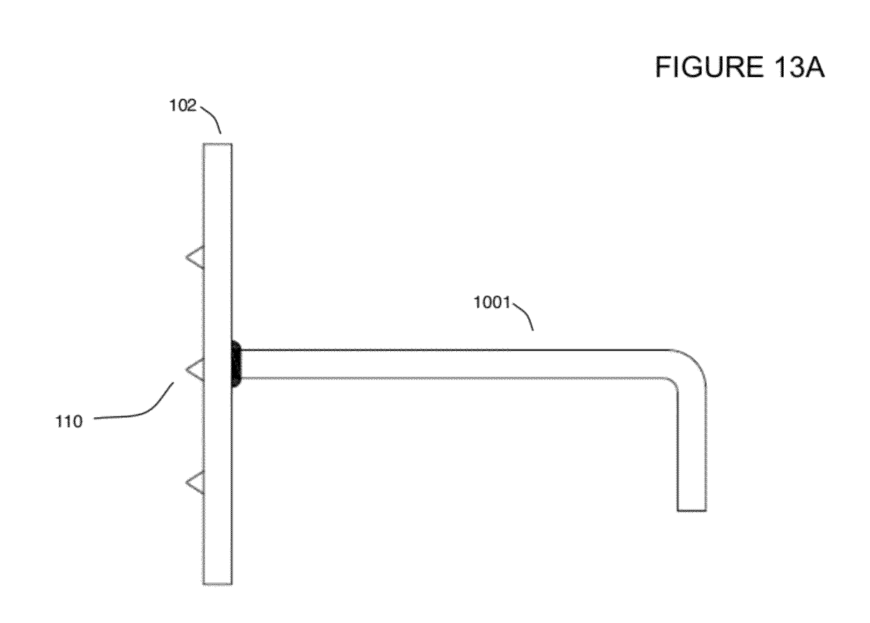

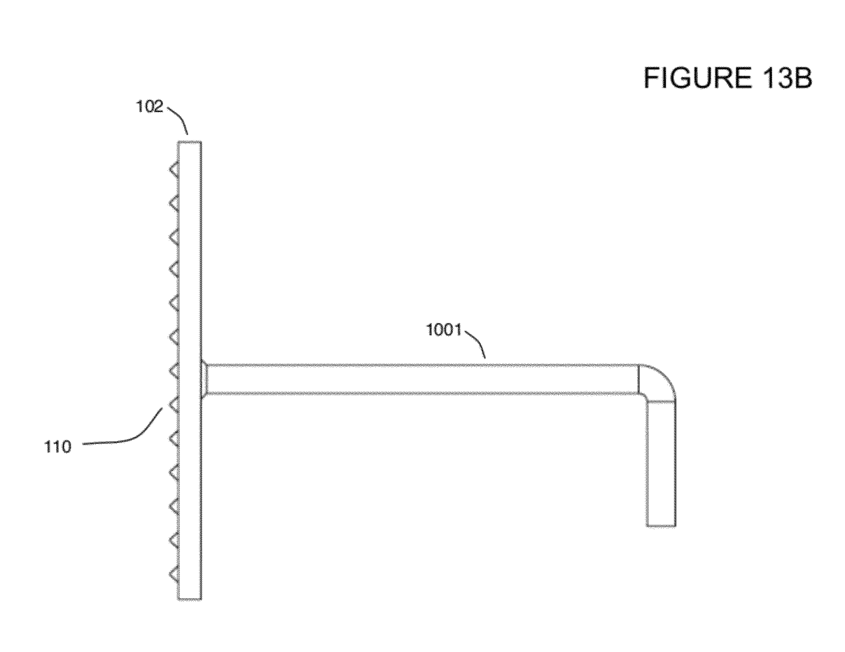

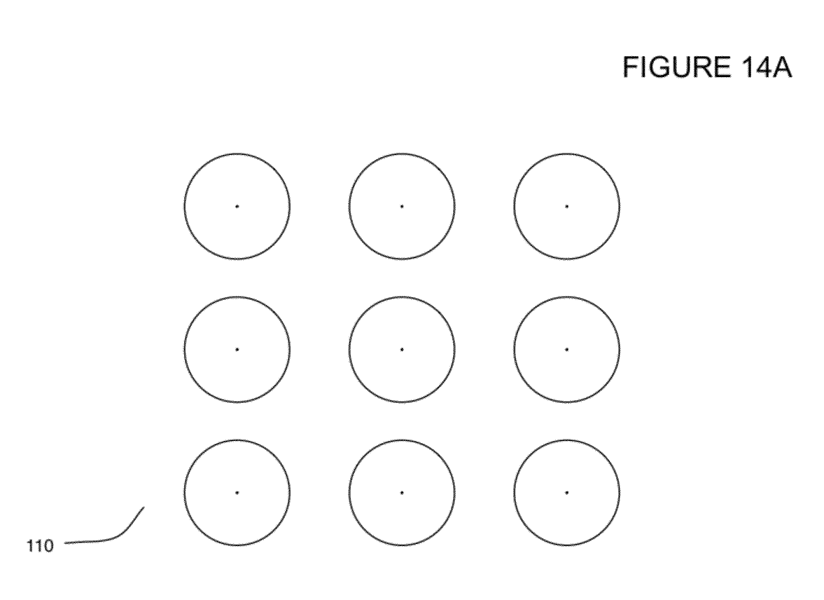

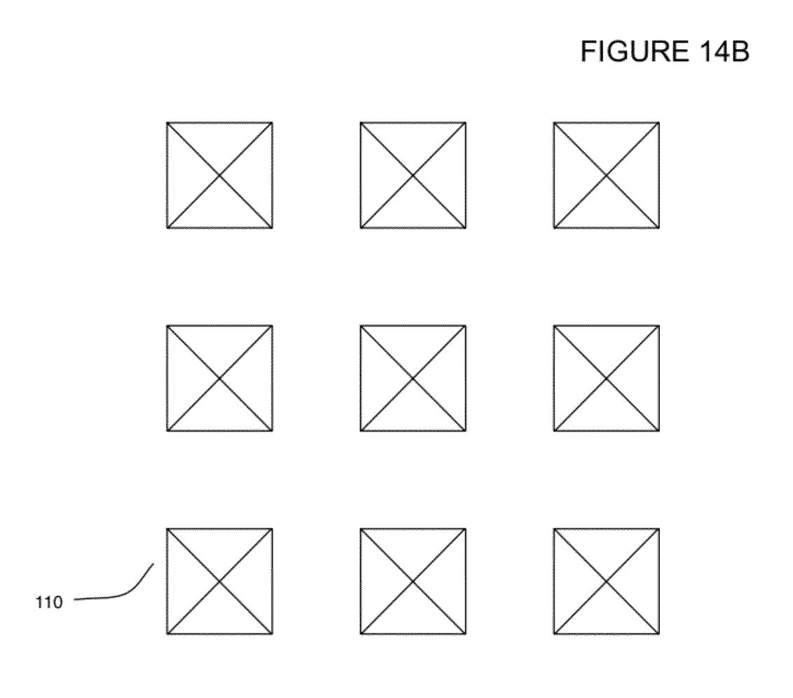

FIG. 11A illustrates a top view of a first embodiment of the plate. FIG. 11B illustrates a top view of a second embodiment of the plate. FIG. 12A illustrates a front view of a first embodiment of the plate. FIG. 12B illustrates a front view of a second embodiment of the plate. FIG. 13A illustrates a side view of a first embodiment of the plate. FIG. 13B illustrates a side view of a second embodiment of the plate. FIG. 14A illustrates a close-up view of a first embodiment of the friction elements 110. FIG. 14B illustrates a close-up view of a second embodiment of the friction elements 110, being more numerous in FIG. 14B with respect to FIG. 14A for example. Friction elements 110 may be of any shape that extends into or out or otherwise deviates from the plane that defines the face of base 101 or plate 102.

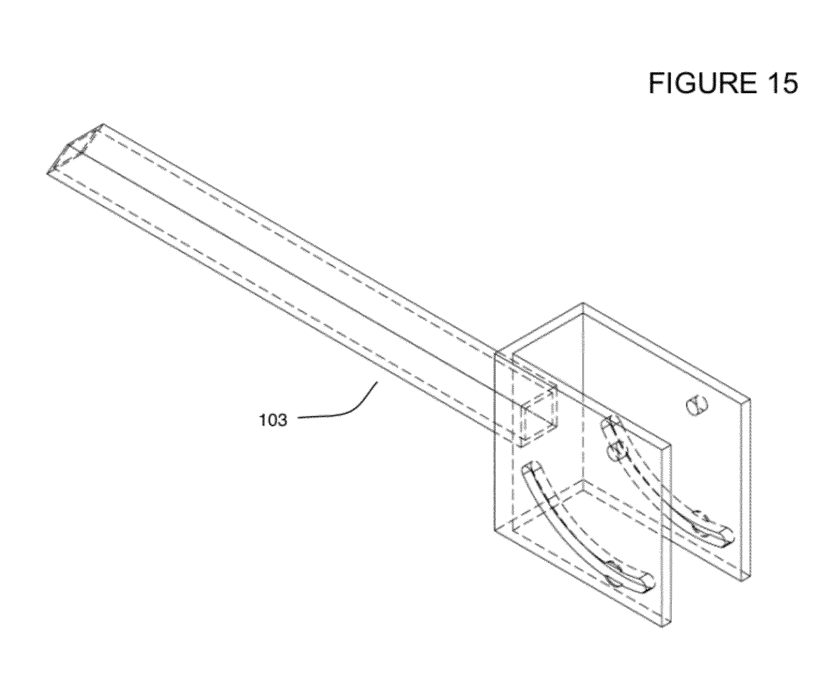

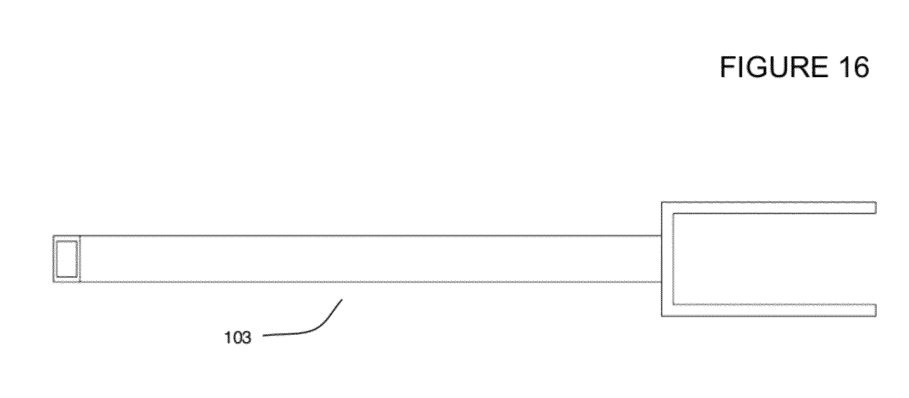

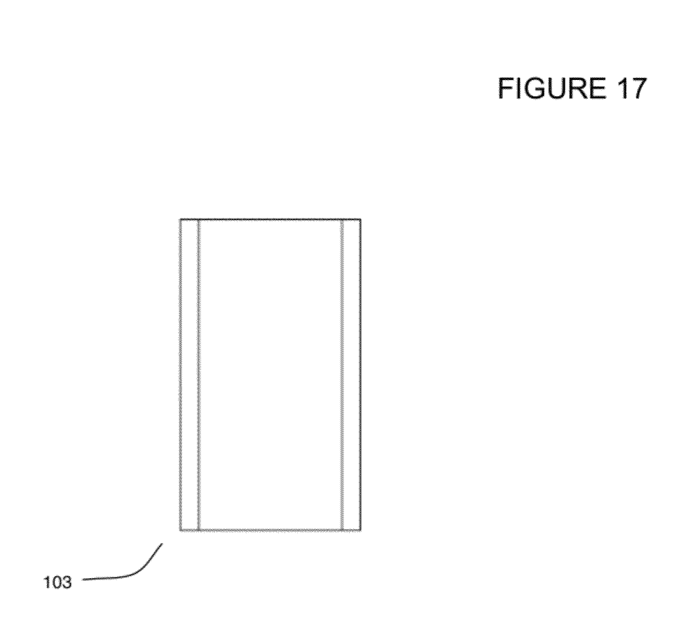

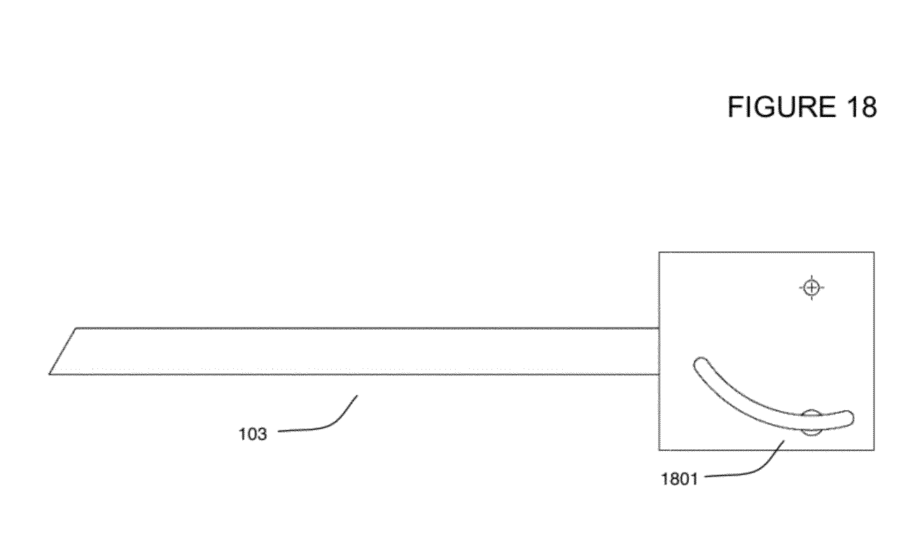

FIG. 15 illustrates a perspective view of an embodiment of arm 103. FIG. 16 illustrates a top view of an embodiment of the arm. FIG. 17 illustrates a front view of an embodiment of the arm. FIG. 18 illustrates a side view of an embodiment of the arm, slot 1801 allows for coupling J-pipe 104 to the arm for elevation adjustment.

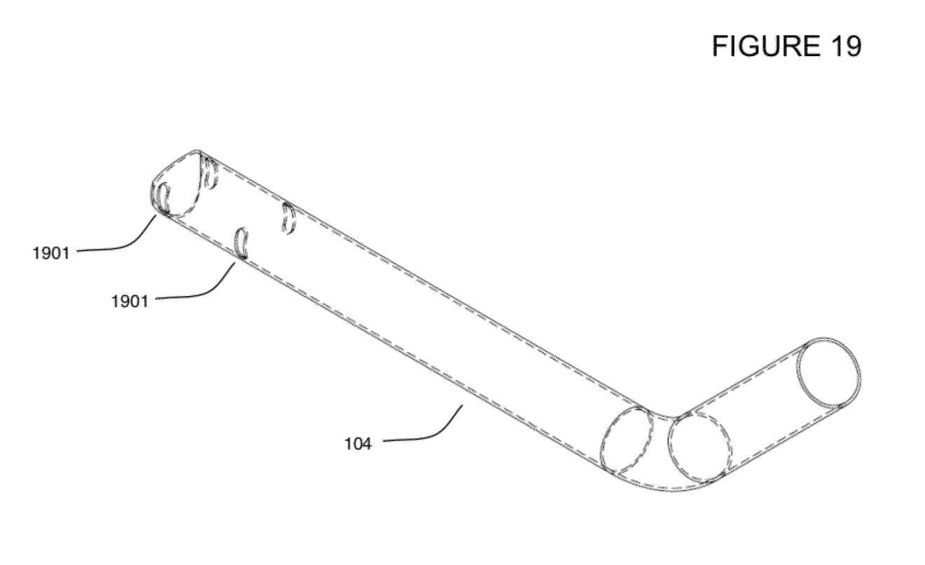

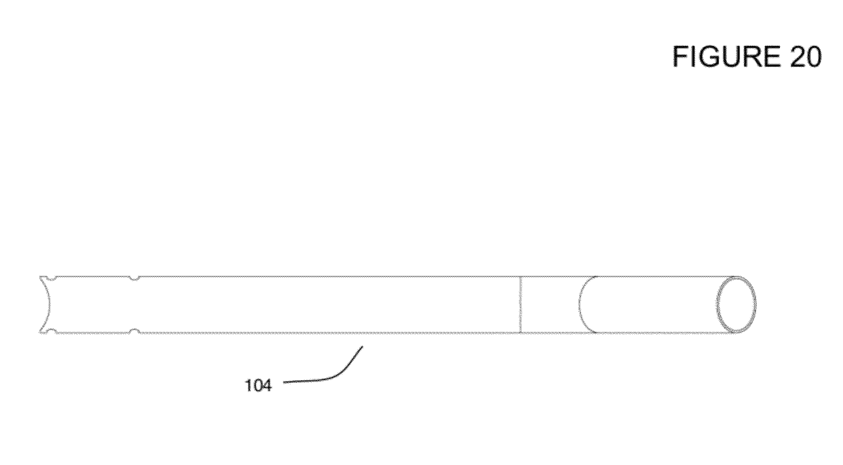

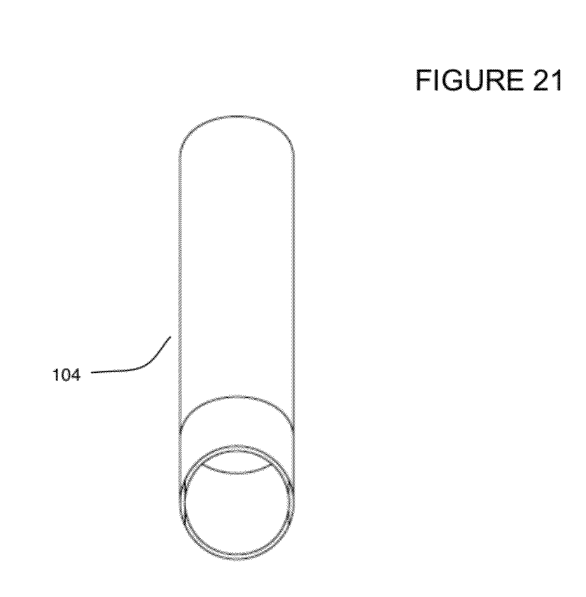

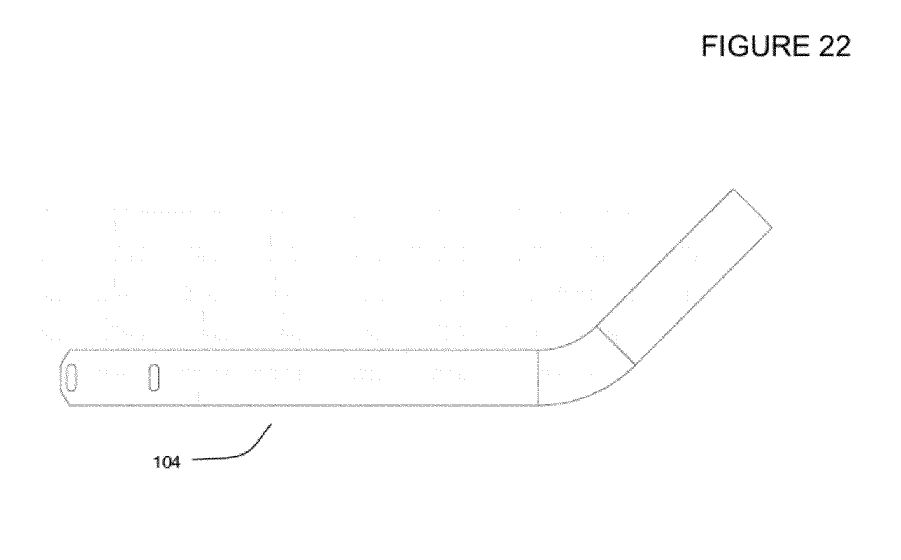

FIG. 19 illustrates a perspective view of an embodiment of J-pipe 104 having slots 1901 (as opposed to simple holes) that allow for azimuth adjustment when coupling with slot 1801 of arm 103. FIG. 20 illustrates a top view of an embodiment of the J-pipe. FIG. 21 illustrates a front view of an embodiment of the J-pipe. FIG. 22 illustrates a side view of an embodiment of the J-pipe.

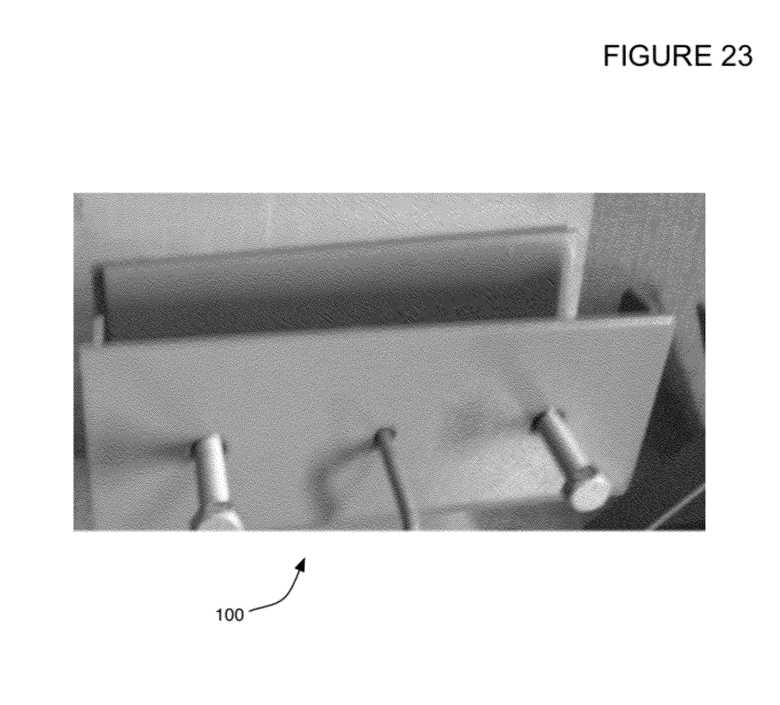

FIG. 23 shows a picture of an embodiment of the invention mounted on a test rafter. Bolts and the L-pin can be seen extending from the base.

Test Results:

Rafter test with rafter in vertical orientation:

With a 34.5 lbf torque applied to the rafter

| | Test 1 | Test 2 |
|---|---|---|
| Initial | 0.0° | 0.0° |
| Load | 0.8° | 0.8° |
| Recovery | 0.0° | 0.0° |

With a 75 lbf torque applied to the rafter

| | Test 1 | Test 2 |
|---|---|---|
| Initial | 0.0° | 0.0° |
| Load | 2.1° | 2.1° |
| Recovery | 0.1° | 0.2° |

Rafter test with rafter in horizontal orientation

With a 34.5 lbf torque applied to the rafter

| | Test 1 | Test 2 |
|---|---|---|
| Initial | 0.0° | 0.0° |
| Load | 0.9° | 0.9° |
| Recovery | 0.0° | 0.0° |

With a 75 lbf torque applied to the rafter

| | Test 1 | Test 2 |
|---|---|---|
| Initial | 0.0° | 0.0° |
| Load | 2.2° | 2.2° |
| Recovery | 0.0° | 0.0° |

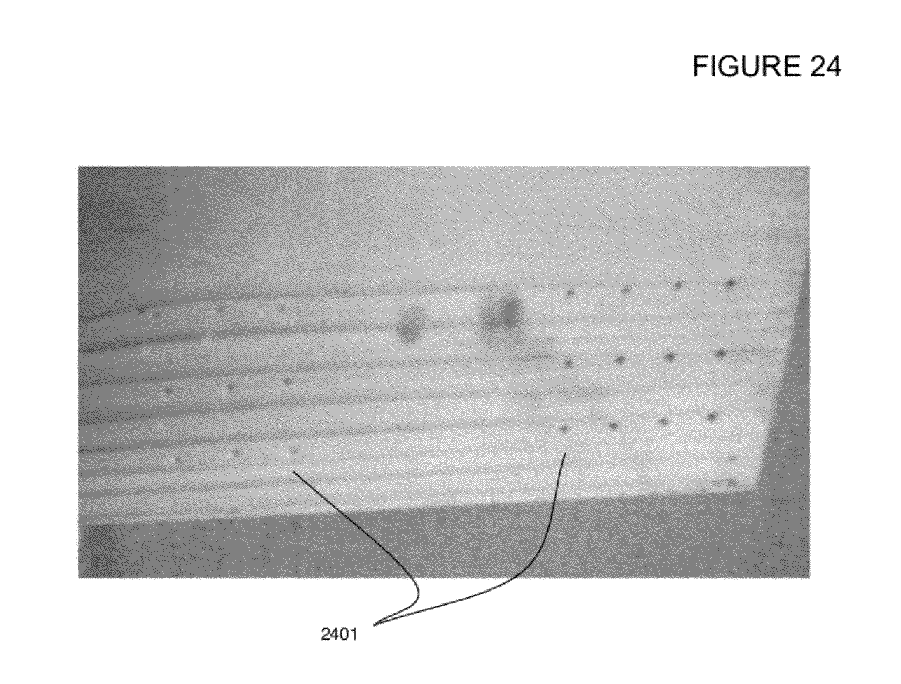

FIG. 24 shows a picture of indentations 2401 that remain on the rafter after an embodiment of the invention is removed from the rafter, wherein the damage to the rafter is minimized.

While the invention herein disclosed has been described by means of specific embodiments and applications thereof, numerous modifications and variations could be made thereto by those skilled in the art without departing from the scope of the invention set forth in the claims.

What is claimed is:

1. A non-penetrating mount for an antenna comprising:
a base having a first side and a second side wherein said first side comprises a first planar surface;
a plate having a second planar surface wherein said plate is configured to reside within said base and wherein said plate is configured to lie in a plane that is parallel to said first side of said base wherein said plate is configured to move toward and away from said base;
an arm coupled with said base; and,
wherein said base and said plate each comprise a plurality of friction elements configured to frictionally engage a rafter without penetrating through said rafter from a first side of said rafter to a second side of said rafter and
wherein said plurality of friction elements of said base protrude out of said first planar surface of said base toward said second planar surface of said plate and
wherein said plurality of friction elements of said plate protrude out of said second planar surface of said plate toward said first planar surface of said base and
wherein said plurality of friction elements each comprise a projection away from first planar surface and second planar surface respectively wherein each projection is of a height with respect to said first planar surface and said second planar surface that is less than the thickness of said base and said plate and
wherein said plurality of friction elements are configured to minimize damage to said rafter when said non-penetrating mount engages said rafter via said plurality of friction elements on said base and said plate.

2. (canceled)

3. (canceled)

4. (canceled)

5. (canceled)

6. The non-penetrating mount for an antenna of claim 1 wherein said friction elements are integral to said base and said plate.

7. The non-penetrating mount for an antenna of claim 1 wherein said friction elements are coupled to said base and said plate.

8. The non-penetrating mount for an antenna of claim 1 wherein said friction elements are welded to said base and said plate.

9. The non-penetrating mount for an antenna of claim 1 wherein said plate is coupled with said base via one force element on said second side of said base.

10. The non-penetrating mount for an antenna of claim 1 wherein said plate is coupled with said base via more than one force element on said second side of said base.

11. The non-penetrating mount for an antenna of claim 1 wherein said arm comprises a rotation joint and wherein said rotation joint is adjustable in azimuth and elevation.

12. The non-penetrating mount for an antenna of claim 1 wherein said plate comprises a pin that is configured to keep said plate from falling out of said base during installation.

13. A non-penetrating mount for an antenna comprising:
a base having a first side and a second side wherein said first side comprises a first planar surface;
a plate having a second planar surface wherein said plate is configured to reside within said base and configured to lie in a plane parallel to said first side of said base wherein said plate is configured to move toward and away from said base;
an arm coupled with said base;
wherein said base and said plate each comprise a plurality of friction elements configured to frictionally engage a rafter without penetrating through said rafter from a first side of said rafter to a second side of said rafter, and
wherein said plurality of friction elements of said base protrude out of said first planar surface of said base toward said second planar surface of said plate and
wherein said plurality of friction elements of said plate protrude out of said second planar surface of said plate toward said first planar surface of said base and
wherein said plurality of friction elements each comprise a projection away from first planar surface and second planar surface respectively wherein each protection is of a height with respect to said first planar surface and said second planar surface that is less than the thickness of said base and said plate and
wherein said plurality of friction elements are configured to minimize damage to said rafter when said non-penetrating mount engages said rafter via said plurality of friction elements on said base and said plate.

14. The non-penetrating mount for an antenna of claim 13 wherein said friction elements are integral to said base and said plate.

15. The non-penetrating mount for an antenna of claim 13 wherein said friction elements are coupled to said base and said plate.

16. The non-penetrating mount for an antenna of claim 13 wherein said plate comprises a pin that is configured to keep said plate from falling out of said base during installation.

17. A non-penetrating mount for an antenna comprising:
a base having a first side and a second side wherein said first side comprises a first planar surface;
a plate having a second planar surface wherein said plate is configured to reside within said base and configured to lie in a plane parallel to said first side of said base wherein said plate is configured to move toward and away from said base;
an arm coupled with said base wherein said arm comprises
a rotation joint;
wherein said base and said plate each comprise a plurality of friction elements configured to frictionally engage a rafter without penetrating through said rafter from a first side of said rafter to a second side of said rafter, and
wherein said plurality of friction elements of said base protrude out of said first planar surface of said base toward said second planar surface of said plate and
wherein said plurality of friction elements of said plate protrude out of said second planar surface of said plate toward said first planar surface of said base and
wherein said plurality of friction elements each comprise a projection away from first planar surface and second planar surface respectively wherein each projection is of a height with respect to said first planar surface and said second planar surface that is less than the thickness of said base and said plate and
wherein said plurality of friction elements are configured to minimize damage to said rafter when said non-penetrating mount engages said rafter via said plurality of friction elements on said base and said plate.

18. The non-penetrating mount for an antenna of claim 17 wherein said friction elements are integral to said base and said plate.

19. The non-penetrating mount for an antenna of claim 17 wherein said friction elements are coupled to said base and said plate.

20. The non-penetrating mount for an antenna of claim 17 wherein said rotation joint is adjustable in azimuth and elevation.
